(19) United States
(12) Patent Application Publication
(10) Pub. No.: US 2026/0116655 A1
(43) Pub. Date: Apr. 30, 2026

(54) REFUSE VEHICLE WITH STATE DISPLAY

(71) Applicant: Oshkosh Corporation, Oshkosh, WI (US)

(72) Inventors: Jeff Meyer, Oshkosh, WI (US); Vince Schad, Oshkosh, WI (US)

(73) Assignee: Oshkosh Corporation, Oshkosh, WI (US)

(21) Appl. No.: 19/003,630

(22) Filed: Dec. 27, 2024

Related U.S. Application Data
(60) Provisional application No. 63/615,644, filed on Dec. 28, 2023.

(51) Int. Cl. B65F 3/04; B65F 3/02

(52) U.S. Cl. CPC B65F 3/04; B65F 2003/025; B65F 2210/168

(57) ABSTRACT

A refuse vehicle includes a chassis, a body coupled to the chassis, a lift assembly, and a controller. The controller includes one or more memory devices storing instructions thereon that, when executed by one or more processors, cause the one or more processors to acquire data indicative of a position of the lift assembly from one or more sensors and determine the position of the lift assembly based on the data from the one or more sensors. The processors generate a graphical representation of the lift assembly in the determined position and cause a display device to display the graphical representation of the lift assembly in the determined position. The processors update the graphical representation according to changes in the position of the lift assembly, such that a real-time position of the lift assembly is displayed on the display device throughout operation of the lift assembly.

### CROSS-REFERENCE TO RELATED APPLICATIONS

This Application claims the benefit of and priority to U.S. Provisional Application No. 63/615,644, filed December 28, 2023, the entire contents of which are hereby incorporated by reference herein.

### BACKGROUND

The present disclosure generally relates to the field of refuse vehicles. More specifically, the present disclosure relates to control systems and display systems for refuse vehicles.

### SUMMARY

One embodiment of the present disclosure relates to a refuse vehicle. The refuse vehicle includes a chassis, a body coupled to the chassis, a lift assembly, and a controller. The controller includes one or more memory devices storing instructions thereon that, when executed by one or more processors, cause the one or more processors to perform operations. The operations include acquiring data indicative of a position of the lift assembly from one or more sensors and determining the position of the lift assembly based on the data from the one or more sensors. The operations include generating a graphical representation of the lift assembly in the determined position and causing a display device to display the graphical representation of the lift assembly in the determined position. The operations also include updating the graphical representation according to changes in the position of the lift assembly, such that a real-time position of the lift assembly is displayed on the display device throughout operation of the lift assembly.

Another embodiment relates to a control system for a refuse vehicle. The control system includes one or more sensors coupled to a lift assembly of the refuse vehicle and a controller. The controller is configured to acquire data indicative of a position of the lift assembly from one or more sensors and determine the position of the lift assembly based on the data from the one or more sensors. The controller is configured to generate a graphical representation of the lift assembly in the determined position, cause a display to display the graphical representation of the lift assembly in the determined position, and update the graphical representation according to changes in the position of the lift assembly. The controller updates the graphical representation such that a real-time position of the lift assembly is displayed on a display device throughout operation of the lift assembly.

Yet another embodiment relates to a method for controlling a refuse vehicle. The method includes acquiring data indicative of a position of a lift assembly of the refuse vehicle from one or more sensors and determining the position of the lift assembly based on the data from the one or more sensors. The method includes generating a graphical representation of the lift assembly in the determined position and causing a display to display the graphical representation of the lift assembly in the determined position. The method further includes updating the graphical representation according to changes in the position of the lift assembly, such that a real-time position of the lift assembly is displayed on a display device throughout operation of the lift assembly.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a block diagram of a control system that gathers positional data of components of any of the refuse vehicles of FIGS. 1-3, according to an exemplary embodiment;

FIG. 5 is a flow diagram of a process for generating a graphical representation of a portion of any of the refuse vehicles of FIGS. 1-3, according to an exemplary embodiment;

FIG. 6 is a first sequential graphical representation of the lift assembly in a downward position, according to an exemplary embodiment;

FIG. 7 is a second sequential graphical representation of the lift assembly in upward motion, according to an exemplary embodiment;

FIG. 8 is a third sequential graphical representation of the lift assembly in a fully upright position, according to an exemplary embodiment; and

FIG. 9 is a fourth sequential graphical representation of the lift assembly in downward motion, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the FIGURES, systems and methods for a refuse vehicle state display system are shown, according to various exemplary embodiments. The refuse vehicle state display system includes a controller configured to receive positional information from inclinometers, position sensors, and/or cameras disposed in various locations on a refuse vehicle. The information is received and processed by the controller to create a graphical representation of the real-time position of components of the refuse vehicle, such as the lift or grabber assembly. The digital model is transmitted to and displayed on a display device, according to exemplary embodiments. In this way, the digital model of the real-time position of components of the refuse vehicle is displayed throughout their operation.

### Front-Loading Configuration

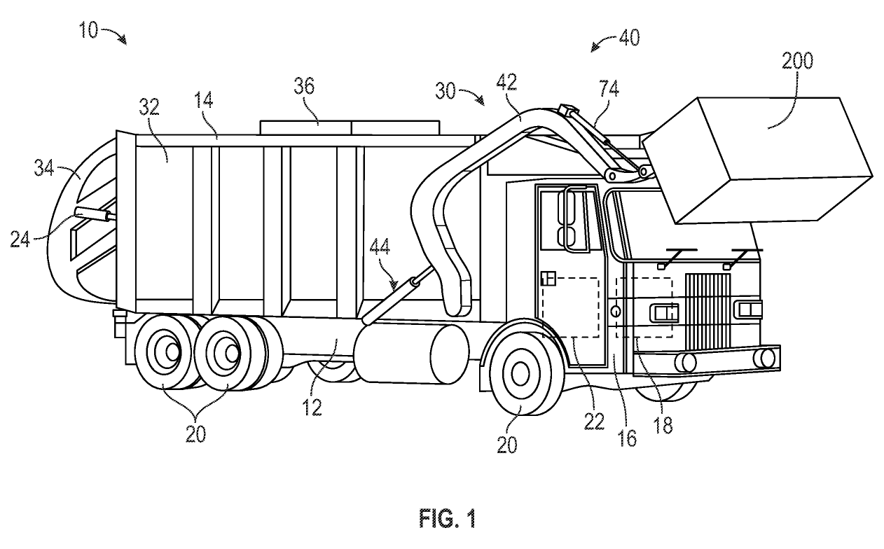

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, biodiesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgates 24. The refuse compartment 30 may be hingedly or pivotally coupled with the frame 12 such that the refuse compartment 30 can be driven to raise or lower while the tailgate 34 is open in order to dump the contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the refuse container 200 as described in greater detail in U.S. Application No. 17/558,183, filed December 12, 2021, the entire disclosure of which is incorporated by reference herein.

### Rear-Loading Configuration

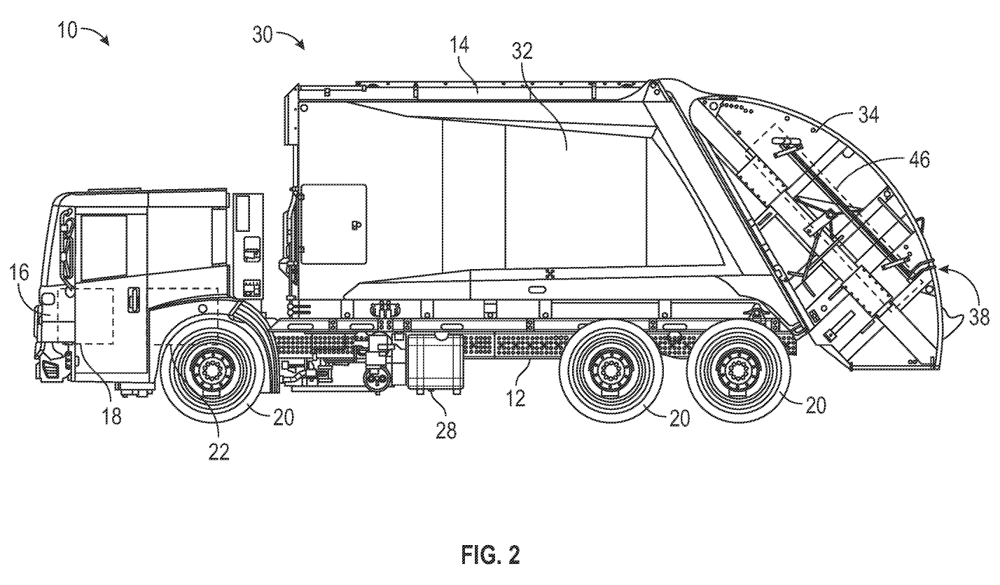

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

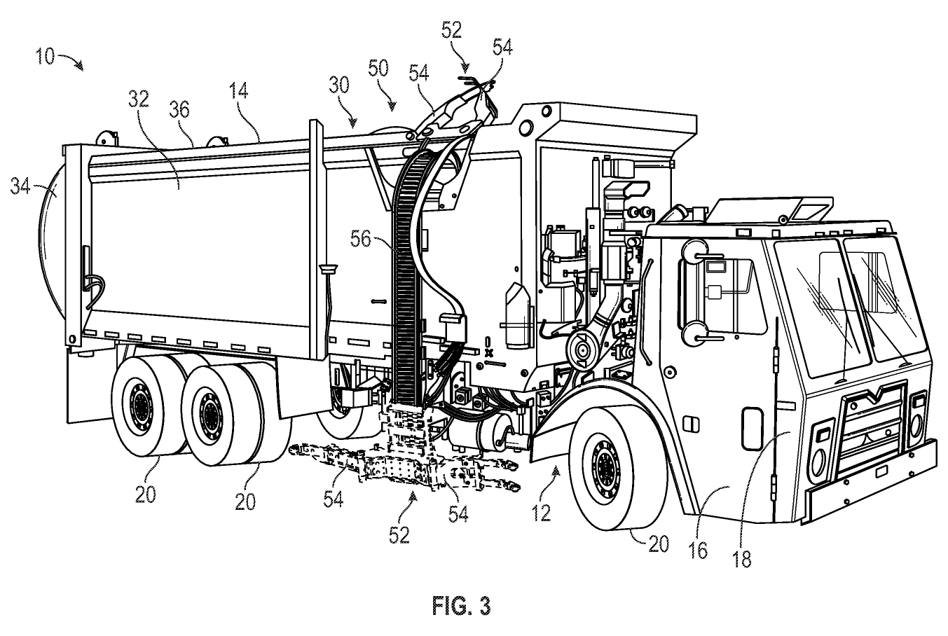

Referring to FIG. 3, the refuse vehicle 10 may be configured as a side-loading refuse vehicle (e.g., a zero-radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly may transition into the disengaged state, releasing the refuse container.

### State Display System

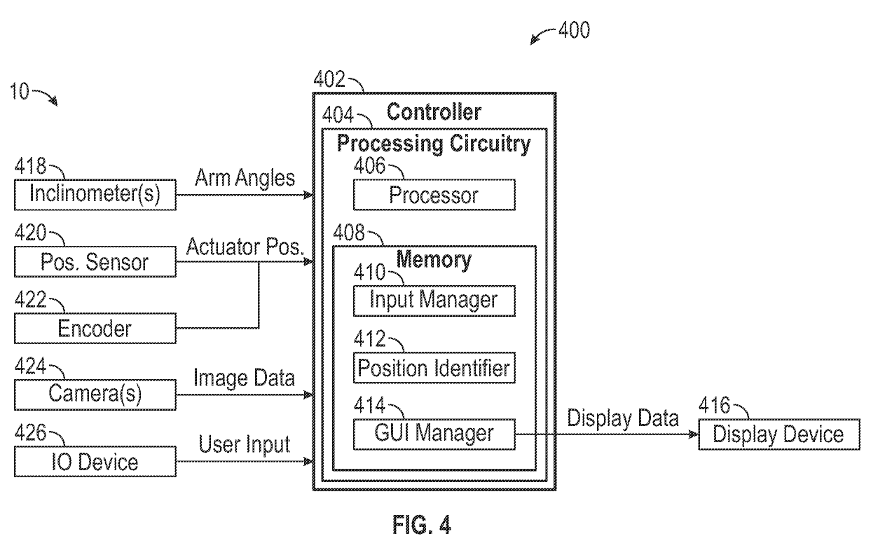

Referring now to FIG. 4, a diagram of a control system 400 for a vehicle state display system is shown, according to exemplary embodiments. The control system 400 includes the controller 402. A controller 402 may be disposed of in any suitable location on the refuse vehicle 10. The controller 402 is shown to include a circuit, shown as a processing circuit 404, a processor, shown as processor 406, and one or more memory devices, shown as memory 408, according to an exemplary embodiment. The controller 402 may be implemented as a general-purpose processor, an application-specific integrated circuit (ASIC), one or more field-programmable gate arrays (FPGAs), a digital-signal processor (DSP), circuits containing one or more processing components, circuitry for supporting a microprocessor, a group of processing components, or other suitable electronic processing components.

The processing circuit 404 may include one or more specialized circuits, shown as an input manager 410, a position identifier 412, and a graphical user interface (GUI) manager 414, stored in the memory 408. The processing circuit 404 may include an ASIC, one or more FPGAs, a DSP, circuits containing one or more processing components, circuitry for supporting a microprocessor, a group of processing components, or other suitable electronic processing components (e.g., processor 406). In some embodiments, the processing circuit 404 is configured to execute computer code stored in memory 408 to facilitate the activities described herein. The memory 408 may be any volatile or non-volatile computer-readable storage medium capable of storing data or computer code relating to the activities described herein. According to an exemplary embodiment, the memory 408 includes computer code modules (e.g., executable code, object code, source code, script code, machine code, etc.) configured for execution by processing circuit 404. The memory 408 includes various actuation profiles corresponding to modes of operation (e.g., for transmission 22, for a vehicle, etc.), according to an exemplary embodiment. In some embodiments, controller 402 may represent a collection of processing devices (e.g., servers, data centers, etc.). In such cases, the processing circuit 404 represents the collective processors of the devices, and the memory 408 represents the collective storage devices of the devices.

The control system 400 is shown to receive data from inclinometer(s) 418, position sensor(s) 420, an encoder 422, camera(s) 424, an input/output device 426. Such data is utilized by the controller 402 to generate a graphical representation of the real-time position components of the refuse vehicle 10, such as the lift or grabber assembly (e.g., the lift assembly 40, the lift assembly 50, etc.), according to exemplary embodiments.

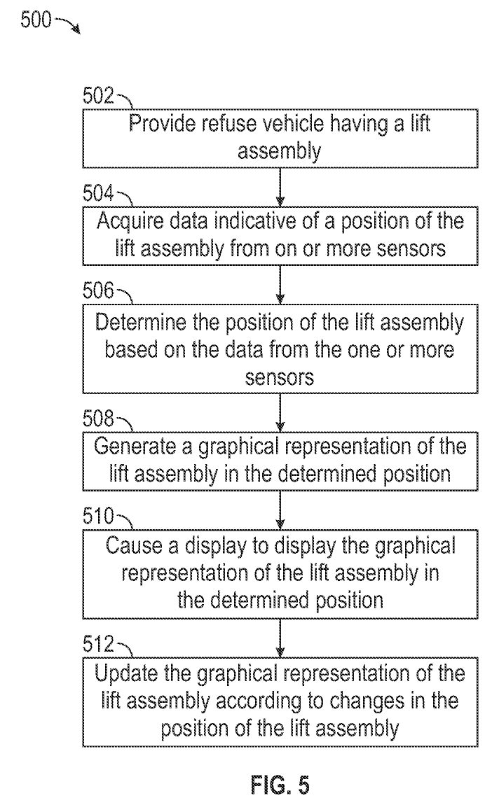

The inclinometer(s) 418 may acquire data indicative of the linear and/or angular displacement of the grabber arms 54, 42, the grabber arm assembly 52, the lift assembly 40, or a combination thereof relative to a default position (e.g., the position of the lift assembly 40 shown in FIG. 5). For example, the inclinometer 418 may collect data indicative of an angular orientation of the lift arms 42 relative to the frame 12. In some examples, the inclinometer 418 is housed within an actuator (e.g., lift arm actuators 44, the fork actuators 74, etc.). In other examples, the inclinometer 418 is positioned on or within the lift arms 42 and/or the forks 72.

The position sensors 420 may be integrated with (e.g., positioned within the housing of) the actuators of the refuse vehicle 10 (e.g., the lift arm actuators 44, the fork actuator 74) to measure a displacement of the actuator (e.g., how far a piston is extended from or retracted into a cylinder) relative to a default position. The position sensors 420 may be magnetic field sensors, radar measurement sensors, or other time-of-flight sensors. In some examples, the position sensor 420 may acquire data indicative of a vertical position of the grabber assembly 52 along the length of the track 56 of the side loading vehicle 10 shown in FIG. 3. In other examples, the position sensor 420 may acquire data indicative of the vertical position, angular position, and/or lateral position of the lift assembly 40.

The encoders 422 may measure a rotational position of the lift assembly 40. For example, the encoders 422 may measure a rotational position of one or more electric motors or screw actuators on the refuse vehicle 10 relative to a default position. Additionally or alternatively, the encoders 422 may measure the rotational position of one or more pivot points/joints. For example, the encoder may measure the rotational position of a pivot point 60 positioned between the lift arms 42 and the frame 12. Similarly, the encoder 422 may measure the rotational position of a pivot point 68 positioned between the forks 72 and the lift arms 42.

One or more cameras 424 may communicate image data to the controller 402. The camera 424 is mounted (e.g., coupled, welded, attached, supported by, etc.) in a location that, depending on the field of view of the camera 424, allows the camera 424 to collect image data for the controller 402 to perform the systems and methods described herein. For example, on a front-end-loading refuse vehicle 10, one or more cameras 424 may be positioned on a front end of the cab 16 such that the lift assembly 40, 50 is in the cameras’ field of view. As another example, one or more cameras 424 may be positioned on the body 14 of the refuse vehicle 10 such that lift assembly 40, 50 is in the cameras’ field of view. This image data may be used to display position on a 360-camera display (e.g., display device 416) within a refuse vehicle 10, according to some embodiments. The camera(s) 424 may supplement the data communicated to the controller 402 by the inclinometer(s) 418 and position sensor(s) 420.

The camera(s) 424 may include 360 cameras or other similar camera systems, according to exemplary embodiments. In some embodiments, the camera systems may be configured in a CartSeeker™ system. The CartSeeker™ camera system includes a camera, a neural network trained for identifying target waste receptacles, and a processor in communication with the camera and the neural network, according to exemplary embodiments. In some embodiments, the cameras are the same or similar to the CartSeeker™ cameras described in U.S. Patent Application No. 17/973,411, filed February 16, 2023, the entire disclosure of which is incorporated by reference herein.

While depicted herein as including a camera 424, the camera 424 can include, or in fact be, other sensors. For example, the camera 424 can be or include any one and/or a combination of camera(s), proximity sensor(s), infrared sensor(s), electromagnetic sensor(s), capacitive sensor(s), photoelectric sensor(s), inductive sensor(s), radar sensor(s), ultrasonic sensor(s), Hall Effect sensor(s), fiber optic sensor(s), Doppler Effect sensor(s), magnetic sensor(s), laser sensor(s) (e.g., LIDAR sensors), sonar sensor(s), and/or the like. In some embodiments, the camera 424 includes an image capture device such as visible light cameras, full-spectrum cameras, image sensors (e.g., a charged-coupled device (CCD), a complementary metal oxide semiconductor (CMOS) sensor, etc.), or any other type of suitable object sensor or imaging device. Accordingly, any reference herein to the camera 424 may also apply to these other types of sensors.

In some embodiments, the camera 424 is active during operation of the refuse vehicle 10. Additionally or alternatively, the camera 424 may become active in response to a detected operation mode of the lift assemblies 40, 50. For example, the camera 424 may activate in response to another sensor (e.g., another camera 424, a low-power camera, a motion detector, etc.) detecting movement of the lift assemblies 40, 50 relative to a default position.

The controller 402 may receive user inputs via an input/output device 426. The input/output is configured to receive user inputs from an operator to facilitate operation of the refuse vehicle 10. The input/output device 426 can include any number of buttons, levers, switches, keys, etc., or any other user input device configured to receive a user input to operate the refuse vehicle 10. For example, the controller 402 can be configured to generate control signals for the various motors, actuators, etc., of the refuse vehicle 10 to operate any of the various motors, actuators, etc. according to inputs made on the input/output device 426. The input/output device 426, or the cab 16, can include a power circuit including any necessary transformers, resistors, transistors, thermistors, capacitors, etc., to provide appropriate power (e.g., electrical energy with appropriate current and/or appropriate voltage) to any of the motors, electric actuators, sensors, electrical devices, etc., of the refuse vehicle 10.

As shown in FIG. 4, the controller 402 receives the angular position measured by the inclinometer(s) 418 and the actuator position measured by the position sensor 420. Similarly, the controller 402 may receive image data indicative of the position of the lift assembly 40, 50. Additionally, the controller 402 receives inputs regarding operational commands from the input/output device 426. The position identifier 412 may utilize the position data, image data, and user inputs received from the various sensors and devices (e.g., the inclinometer 418, position sensor 420, encoder 422, camera 424, input/output device 426, etc.) to determine the position of the lift assembly 40, 50 in real-time or nearly real-time. In some examples, the position identifier 412 stores a lookup table that correlates input position data and/or image data to an associated output. The associated output may be a position of the assembly associated with the input position data. For example, if an input for a front-loading refuse vehicle 10 is an overall length of the lift arm actuator 44 (e.g., a measure of how extended or retracted the actuator is), the output may be an expected position of the lift arms 42. Continuing this example, an input from the position sensor 420 indicating that the lift arm actuator 44 is fully or nearly fully extended (e.g., defining a predetermined maximum length of the lift arm actuator 44) correlates to the lift arms 42 in a downward position in which the forks 42 are positioned in front of the cab 16. Similarly, an input from the position sensor 420 indicating that the lift arm actuator 44 is fully or nearly fully retracted (e.g., defining a predetermined minimum length of the lift arm actuator 44) correlates to the lift arms 42 in an upward position in which the forks 42 are positioned over the refuse compartment 30.

In some examples, the position identifier 412 may perform image recognition on the image data transmitted from the cameras 424 to determine a position of the assembly associated with the image data. The GUI manager 414 is configured to generate a graphical representation of the lift assembly 40 in the determined position and display the graphical representation on a display device 416. The graphical representation may be displayed on the display device 416 automatically (e.g., in immediate or nearly immediate response to sensed movement in lift assembly 40) or in response to user-inputted demand on an input/output device 426. The display device 416 may be arranged within a cab 16 of the refuse vehicle 10 or may be a user device, according to some embodiments.

By way of example, the position sensor 420 may measure the position of the grabber arms 54 along a track 56 and transmit such positional data to the controller 402. Similarly, the inclinometer 418 may measure the angular position of the grabber arms 54 relative to a default position and transmit such angular position data to the controller 402. The controller 402 may use the position of the grabber arm assembly 52 measured by the inclinometer(s) 418 and the position measured by the position sensor 420 to process the real-time position of the grabber arm assembly 52 via the processor 406. The memory 408 may manage the inputs from processor 406 via the input manager 410 and identify the real-time position of the grabber arm assembly 52 via the position identifier 412. The GUI manager 414 may then create a graphical representation of the real-time position of grabber arm assembly 52 and display this graphical representation on display device 416. The GUI manager 414 may cause the display device 416 to display the graphical representation automatically in immediate response to sensed movement in grabber arm assembly 52) or in response to user-inputted demand on an input/output device 426. In other embodiments, inclinometer(s) 418, position sensor(s) 420, or cameras 424 may be used to collect and display angular and positional data on the refuse vehicle’s internal pack position or tailgate position.

Referring to FIG. 5, a flow diagram of a process 500 for generating graphical representations of the lift assembly (e.g., lift assembly 40, 50) of a refuse vehicle 10 is shown, according to an exemplary embodiment. The process 500 is performed by the controller 402, according to some embodiments.

At step 502, a user is provided with a refuse vehicle 10. The refuse vehicle 10 may be any of the types of refuse vehicles 10 shown in FIGS. 1-3 (e.g., front loading, rear loading, side loading, etc.). In this example, the refuse vehicle 10 includes a lift assembly (e.g., lift assembly 40, 50).

At step 504, the controller 402 acquires data indicative of a position of the lift assembly of the refuse vehicle 10 from one or more sensors or devices (e.g., the inclinometer 418, the position sensor 420, the encoder 422, the camera(s) 424, the input/output device 426, etc.). The controller 402 may receive/acquire data from the sensors continuously, nearly continuously, or in preset intervals (e.g., every 10-30 seconds, every minute, etc.). For example, the controller 402 may receive user inputs from the input/output device 426 regarding operational commands for the lift assemblies (e.g., a user operating an input mechanism, or mechanisms, associated with the lift assemblies to reposition the lift assemblies). Upon receiving a user input from the input/output device 426 indicating a desire to reposition the lift assemblies 40, 50, the controller 402 may retrieve or begin receiving data from the inclinometer 418, the position sensor 420, the encoder 422, and/or the camera(s) 424.

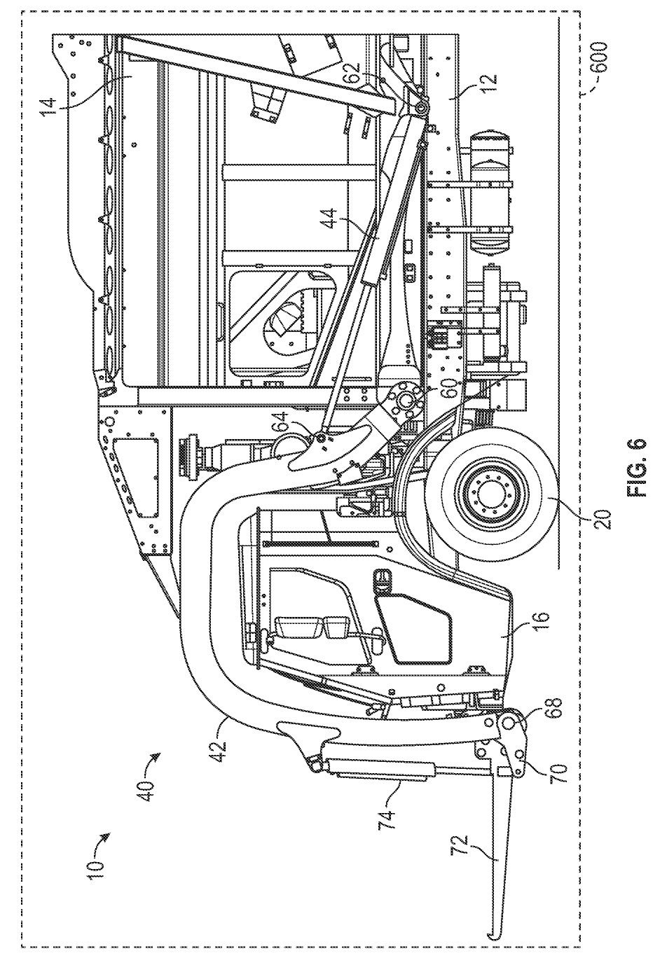

As discussed above, the controller 402 may receive data indicative of the angular position of the lift assembly from the inclinometer 418. For example, the controller 402 may receive data indicative of an angular position of the arms 42 of the lift assembly 40 relative to the frame 12 of the vehicle 10, and/or relative to a ground plane. Similarly, the controller 402 may receive data indicative of the vertical position of the lift assembly and/or the position of the actuators (e.g., the actuators 44, 74 shown in FIGS. 6-9). For example, the controller 402 may receive data indicative of how far the lift arm actuator 44 is extended or retracted from the position sensor 420. Additionally or alternatively, the controller 402 may receive data indicative of a vertical position of the lift arms 42 relative to the frame 12 of the vehicle or relative to the ground plane from the position sensor 420.

The controller 402 may also receive data from the encoders 422 indicative of a rotational position of the lift assembly 40. Such data may be received in addition to or as an alternative to the angular data received from the inclinometer(s) 418. For example, the controller may receive data indicative of a rotational position of one or more electric motors or screw actuators on the refuse vehicle 10 relative to a default position from the encoders 422. As another example, the controller 402 may receive data indicative of the rotational position of a pivot point 60 positioned between the lift arms 42 and the frame 12 from the encoder 422. Similarly, the controller 402 may receive data indicative of the rotational position of a pivot point 68 positioned between the forks 72 and the lift arms 42 from the encoder 422.

The controller 402 may receive image data from the cameras 424 indicative of the position of the lift assembly of the refuse vehicle 10. Sensor data captured by the cameras 424 may include, for example, raw image data from one or more cameras (e.g., visible light cameras) and/or proximity data from one or more sensors (e.g., LIDAR, radar, etc.) that may be used to detect objects (e.g., components of the lift assemblies 40, 50, etc.). In other embodiments, sensor data captured by the camera 424 is video feed data obtained from the camera 424 regarding one or more areas in and/or surrounding the refuse vehicle 10. For example, the image data may be or include video feed data (e.g., live or real-time video feed data) of the front, sides, and/or rear of the refuse vehicle 10. In some embodiments, multiple cameras 424 may be used in order to provide multiple feeds of image data to the controller 402, which may be configured to compile (e.g., cross-reference based on known relative locations of the multiple cameras 424) the image data.

At step 506, the controller 402 determines a position of the lift assembly (e.g., relative to a default position) based on the data acquired from the sensors (e.g., the inclinometer 418, the position sensor 420, the encoder 422, the camera(s) 424, etc.). The controller 402 may determine the position of the lift assembly in real-time or nearly real-time based on the sensor data. In some examples, the controller 402 may apply a model (e.g., a lookup table, machine learning model, statistical model, etc.) to project future positions of the lift assembly based on one or more points of sensor data. For example, if sensor data is transmitted once every 10 seconds, the controller 402 may estimate the position of the lift assembly between the data transmission intervals to fill in gaps in the data.

At step 508, the controller 402, or more specifically the GUI manager 414, generates a graphical representation of the lift assembly of the refuse vehicle 10 based on the determined position of the lift assembly. In exemplary embodiments, the determined position is a real-time or nearly real-time position of the lift assembly. For example, as shown in FIGS. 6-9, the controller 402 may continuously or periodically generate a graphical representation of the lift assembly in various positions throughout operation. At step 510 the controller 402 causes a display (e.g., the display device 416) to display a graphical representation of the lift assembly in a real-time/current position. In this way, a user may view the real-time or nearly real-time position of the lift assembly during operation (e.g., while lifting the refuse container 200). At step 512, the controller 402 may update or generate new graphical representations of the lift assembly according to new position and image data. In this way, the graphical representation of the lift assembly may be continuously updated, such that a user may view the real-time position of the lift assembly throughout its operation. Advantageously, this may allow users to have a more complete view of the lift assembly relative to the view of the lift assembly they have from inside the cab 16.

Referring now to FIGS. 6-9, sequential graphical representations of the lift assembly 40 of a front-end loading refuse vehicle 10 are shown, according to exemplary embodiments. As shown in FIGS. 5-8, the GUI manager 414 is configured to generate graphical representations of a side view of a portion of the refuse vehicle 10 and the lift assembly 40. In other examples, the GUI manager 414 may generate graphical representations of other views of the lift assembly 40 (e.g., perspective views, top views, etc.). Although the graphical representations shown in FIGS. 5-8 depict the lift assembly 40 of a front-loading refuse vehicle 10, the GUI manager 414 may generate similar graphical representations, for example, of the lift assembly 50 of a side-loading refuse vehicle 10, or the tailgate 34 of a rear-loading refuse vehicle 10. In some embodiments, the GUI manager 414 causes the graphical representation to be displayed on a user device (e.g., a mobile phone, laptop, tablet, computer, etc.). Additionally or alternatively, the graphical representation may be displayed on the display device 416 associated with the vehicle (e.g., a dashboard display, a passenger display, etc.).

Referring specifically to FIG. 6, the graphical representation of the lift assembly 40, shown as GUI 600, shows the lift assembly 40 in a downward position. In some examples, the position of the lift assembly 40 shown in FIG. 6 may be the default position. In other examples, the default position is similar to the position shown in FIG. 6, except that the forks 72 may be retracted such that they are vertical or substantially vertical. In this example, the position sensors 420 and/or the encoders 422 may transmit data to the controller 402 indicating that the lift arm actuator 44 and the fork actuator 74 are fully extended. Responsive to receiving data indicating that the lift arm actuator 44 and fork actuator 74 are fully extended, the controller 402 may generate a graphical representation of both the arms 42 and the forks 72 in the downward position. The controller 402 causes the display device 416 to display the graphical representation of the lift assembly 40 in the downward position.

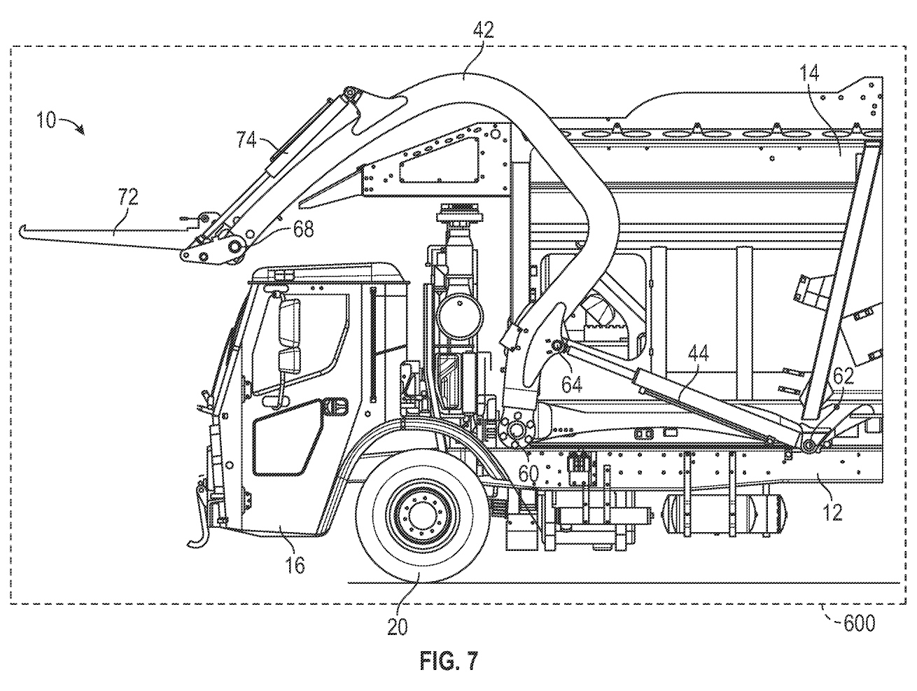

Referring now to FIG. 7, a sequential graphical representation of the lift assembly 40 in upward motion is shown. The lift arm actuator 44 is coupled to a proximal pivot point 62 and a distal pivot point 64. The lift arm actuator 44 may extend and contract linearly while pivoting about the proximal pivot point 62 and the distal pivot point 64. In this way, the lift arm actuator 44, in conjunction with pivot points 62 and 64, controls the rotational motion of the lift arms 42 via the arm pivot point 60. The inclinometer 418 may be integrated into the lift assembly 40 to measure the angle of the lift arms 42 relative to the frame 12 and/or the ground plate while the lift assembly 40 is in motion. As discussed above, the lift arm actuator 44 and fork actuator 74 may include position sensors 420 and/or encoders 422 that measure the extension or retraction of the actuators 44, 74. Additionally or alternatively, the position sensors 420 and/or encoders 422 may measure a position of the actuators 44, 74 themselves relative to their coupling points (e.g., the proximal pivot point 62, the distal pivot point 64, etc.). In this way, the real-time position of the lift arm actuator 44, the fork actuator 74, the lift arms 42, and the forks 72 (e.g., via the inclinometer 418, the position sensors 420, and/or the encoder 422, etc.) are transmitted to the controller 402. The controller 402 utilizes such data to generate the graphical representation of the lift assembly 40 according to the real-time position of the various components of the lift assembly 40 (e.g., the position of the lift arm actuator 44, the fork actuator 74, the lift arms 42, the forks 72, etc.).

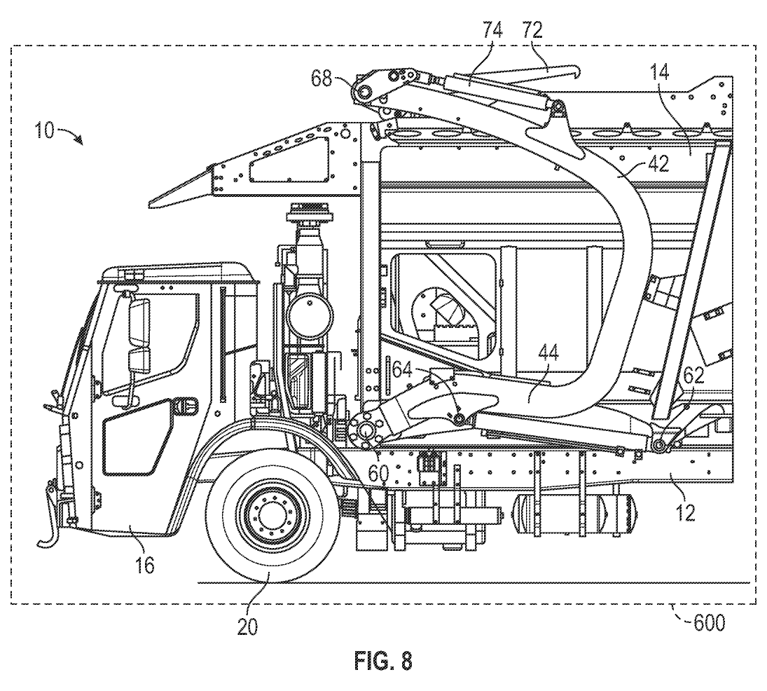

Referring now to FIG. 8, a sequential graphical representation of the lift assembly 40 in its furthest upright position is shown. In this example, the position sensors 420 and/or the encoders 422 may transmit data to the controller 402 indicating that the lift arm actuator 44 and the fork actuator 74 are fully retracted. For example, the fork actuator 74 pulls linearly away from the distal pivot point 70, causing rotational motion of the forks 72 about the fork pivot point 68. In this position, the fork actuator 74 is at its point of furthest contraction, which has pulled the forks 72 into a position nearly parallel (e.g., +/- 20 degrees from parallel, etc.) to the fork actuator 74. Responsive to receiving data indicating that the lift arm actuator 44 and fork actuator 74 are fully retracted, the controller 402 may generate a graphical representation of both the arms 42 and the forks 72 in the furthest upright position. The controller 402 causes the display device 416 to display the graphical representation of the lift assembly 40 in the fully upright position.

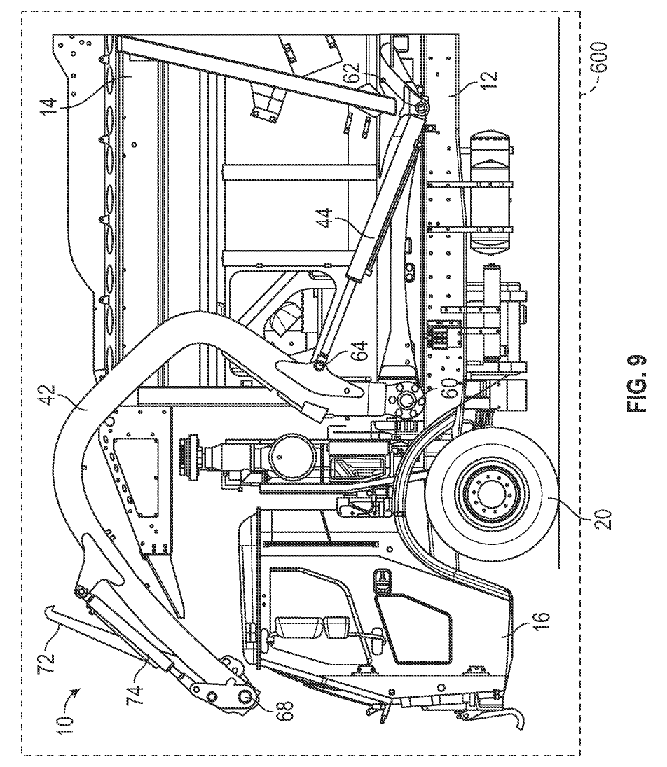

Referring now to FIG. 9, a sequential graphical representation of the lift assembly 40 in downward motion is shown. As shown in FIG. 9, the fork actuator 74 is at its point of furthest contraction, which has pulled the forks 72 into a position nearly parallel to the fork actuator 74. While traveling downwards, the lift arm actuator 44 may extend outward towards the distal pivot point 64 to push the arm 42 to rotate downward, about the arm pivot point 60. Responsive to receiving data indicating that the fork actuator 74 is fully contracted and the lift arm actuator 44 is extending, the controller 402 may generate a graphical representation of the lift arms 42 according to the data indicative of the angular position of the arms 42 transmitted by the inclinometer 418 and/or the position sensor 420, and/or according to the extension and angular position of the lift arm actuator 44. The controller 402 causes the display device 416 to display the graphical representation of the lift assembly 40 in the fully upright position.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium that can be used to carry or store desired program code in the form of machine-executable instructions or data structures and that can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data that cause a general purpose computer, special purpose computer, or special purpose processing machines to perform a certain function or group of functions.

As utilized herein with respect to numerical ranges, the terms “approximately,” “about,” “substantially,” and similar terms generally mean +/- 10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the terms “exemplary” and “example” as used herein to describe various embodiments are intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language, such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from the scope of the present disclosure or from the spirit of the appended claims.

What is claimed is:

1. A refuse vehicle comprising:
a chassis;
a body coupled to the chassis;
a lift assembly; and
a controller comprising one or more memory devices storing instructions thereon that, when executed by one or more processors, cause the one or more processors to:
acquire data indicative of a position of the lift assembly from one or more sensors;
determine the position of the lift assembly based on the data from the one or more sensors;
generate a graphical representation of the lift assembly in the determined position;
cause a display device to display the graphical representation of the lift assembly in the determined position; and
update the graphical representation according to changes in the position of the lift assembly, such that a real-time position of the lift assembly is displayed on the display device throughout operation of the lift assembly.

2. The refuse vehicle of claim 1, wherein the one or more sensors are at least one of (a) an inclinometer, (b) a position sensor, (c) an encoder, or (d) a camera.

3. The refuse vehicle of claim 2, wherein the lift assembly comprises:
lift arms rotatably coupled to the chassis;
a first actuator coupled to the lift arms and configured to (a) contract to raise the lift arms and (b) extend to lower the lift arms;
forks rotatably coupled to the lift arms; and
a second actuator coupled to the forks and configured to (a) contract to raise the forks and (b) extend to lower the forks.

4. The refuse vehicle of claim 3, wherein the one or more sensors include the inclinometer and the inclinometer is configured to measure an angular position of the lift arms relative to the chassis, and
wherein the instructions, when executed by the one or more processors, cause the one or more processors to:
acquire data indicative of the angular position of the lift arms relative to the chassis from the inclinometer; and
generate a graphical representation of the lift arms in the angular position relative to the chassis based on the acquired data.

5. The refuse vehicle of claim 3, wherein the one or more sensors include a first position sensor coupled to the first actuator, the first position sensor configured to measure an overall length of the first actuator, and a second position sensor coupled to the second actuator, the second position sensor configured to measure an overall length of the second actuator, and
wherein the instructions, when executed by the one or more processors, cause the one or more processors to:
acquire data indicative of the overall length of the first actuator from the first position sensor;
determine a position of the lift arms associated with the acquired length of the first actuator;
acquire data indicative of the overall length of the second actuator from the second position sensor;
determine a position of the forks associated with the acquired length of the second actuator; and
generate a graphical representation of the lift arms and the forks according to the determined positions.

6. The refuse vehicle of claim 3, wherein the one or more sensors include the encoder and the encoder is configured to measure a rotational position of the lift arms relative to a default position, and
wherein the instructions, when executed by the one or more processors, cause the one or more processors to:
acquire data indicative of the rotational position of the lift arms relative to the default position from the encoder; and
generate a graphical representation of the lift arms in the acquired rotational position.

7. The refuse vehicle of claim 3, wherein the one or more sensors include the camera and the camera is configured to collect image data indicative of the position of the lift arms and the position of the forks, and
wherein the instructions, when executed by the one or more processors, cause the one or more processors to:
acquire image data indicative of the position of the lift arms;
acquire image data indicative of the position of the forks;
determine a position of the lift arms and the position of the forks based on the acquired image data; and
generate a graphical representation of the lift arms and the forks according to the determined position.

8. A control system for a refuse vehicle, the control system comprising:
one or more sensors coupled to a lift assembly of the refuse vehicle; and
a controller configured to:
acquire data indicative of a position of the lift assembly from one or more sensors;
determine the position of the lift assembly based on the data from the one or more sensors;
generate a graphical representation of the lift assembly in the determined position;
cause a display to display the graphical representation of the lift assembly in the determined position; and
update the graphical representation according to changes in the position of the lift assembly, such that a real-time position of the lift assembly is displayed on a display device throughout operation of the lift assembly.

9. The control system of claim 8, wherein the one or more sensors are at least one of (a) an inclinometer, (b) a position sensor, (c) an encoder, or (d) a camera.

10. The control system of claim 9, wherein the lift assembly comprises:
lift arms rotatably coupled to a chassis;
a first actuator coupled to the lift arms and configured to (a) contract to raise the lift arms and (b) extend to lower the lift arms;
forks rotatably coupled to the lift arms; and
a second actuator coupled to the forks and configured to (a) contract to raise the forks and (b) extend to lower the forks.

11. The control system of claim 10, wherein the one or more sensors include the inclinometer and the inclinometer is configured to measure an angular position of the lift arms relative to a chassis of the refuse vehicle, and
wherein the controller is configured to:
acquire data indicative of the angular position of the lift arms relative to the chassis from the inclinometer; and
generate a graphical representation of the lift arms in the angular position relative to the chassis based on the acquired data.

12. The control system of claim 10, wherein the one or more sensors include a first position sensor coupled to the first actuator, the first position sensor configured to measure an overall length of the first actuator, and a second position sensor coupled to the second actuator, the second position sensor configured to measure an overall length of the second actuator, and
wherein the controller is configured to:
acquire data indicative of the overall length of the first actuator from the first position sensor;
determine a position of the lift arms associated with the acquired overall length of the first actuator;
acquire data indicative of the overall length of the second actuator from the second position sensor;
determine a position of the forks associated with the acquired overall length of the second actuator; and
generate a graphical representation of the lift arms and the forks according to the determined positions.

13. The control system of claim 10, wherein the one or more sensors include the encoder and the encoder is configured to measure a rotational position of the lift arms relative to a default position, and
wherein the controller is configured to:
acquire data indicative of the rotational position of the lift arms relative to the default position from the encoder; and
generate a graphical representation of the lift arms in the acquired rotational position.

14. The control system of claim 10, wherein the one or more sensors include the camera, and the camera is configured to collect image data indicative of the position of the lift arms and the position of the forks, and
wherein the controller is configured to:
acquire image data indicative of the position of the lift arms;
acquire image data indicative of the position of the forks;
determine a position of the lift arms and the position of the forks based on the acquired image data; and
generate a graphical representation of the lift arms and the forks according to the determined position.

15. A method for controlling a refuse vehicle, the method comprising:
acquiring data indicative of a position of a lift assembly of the refuse vehicle from one or more sensors;
determining the position of the lift assembly based on the data from the one or more sensors;
generating a graphical representation of the lift assembly in the determined position;
causing a display to display the graphical representation of the lift assembly in the determined position; and
updating the graphical representation according to changes in the position of the lift assembly, such that a real-time position of the lift assembly is displayed on a display device throughout operation of the lift assembly.

16. The method of claim 15, wherein the lift assembly comprises:
lift arms rotatably coupled to a chassis;
a first actuator coupled to the lift arms and configured to (a) contract to raise the lift arms and (b) extend to lower the lift arms;
forks rotatably coupled to the lift arms; and
a second actuator coupled to the forks and configured to (a) contract to raise the forks and (b) extend to lower the forks.

17. The method of claim 16, wherein the one or more sensors include an inclinometer and the inclinometer is configured to measure an angular position of the lift arms relative to the chassis, the method further comprising:
acquiring data indicative of the angular position of the lift arms relative to the chassis from the inclinometer; and
generating a graphical representation of the lift arms in the angular position relative to the chassis based on the acquired data.

18. The method of claim 16, wherein the one or more sensors include a first position sensor coupled to the first actuator, the first position sensor configured to measure an overall length of the first actuator, and a second position sensor coupled to the second actuator, the second position sensor configured to measure an overall length of the second actuator, the method further comprising:
acquiring data indicative of the overall length of the first actuator from the first position sensor;
determining a position of the lift arms associated with the acquired length of the first actuator;
acquiring data indicative of the overall length of the second actuator from the second position sensor;
determining a position of the forks associated with the acquired length of the second actuator; and
generating a graphical representation of the lift arms and the forks according to the determined positions.

19. The method of claim 16, wherein the one or more sensors include an encoder and the encoder is configured to measure a rotational position of the lift arms relative to a default position, the method further comprising:
acquiring data indicative of the rotational position of the lift arms relative to the default position from the encoder; and
generating a graphical representation of the lift arms in the acquired rotational position.

20. The method of claim 16, wherein the one or more sensors include a camera and the camera is configured to collect image data indicative of the position of the lift arms and the position of the forks, the method further comprising:
acquiring image data indicative of the position of the lift arms;
acquiring image data indicative of the position of the forks;
determining a position of the lift arms and the position forks based on the acquired image data; and
generating a graphical representation of the lift arms and the forks according to the determined position.
